(19) United States
(12) Patent Application Publication
(10) Pub. No.: US 2024/0090719 A1
(43) Pub. Date: Mar. 21, 2024

(54) VACUUM DRILL DUST EXTRACTOR

(71) Applicant: Werner Meyer, Nördlingen (DE)

(72) Inventor: Werner Meyer, Nördlingen (DE)

(21) Appl. No.: 18/240,316

(22) Filed: Aug. 30, 2023

(30) Foreign Application Priority Data
Sep. 7, 2022 (DE) 10 2022 003 296.1

(51) Int. Cl. A47L 7/00; A47L 5/14; A47L 5/20; A47L 9/12; A47L 9/28; B23Q 11/00

(52) U.S. Cl. CPC A47L 7/0095; A47L 5/14; A47L 5/20; A47L 9/12; A47L 9/2857; A47L 9/2884; B23Q 11/0046

(57) ABSTRACT

In a vacuum drill dust extractor having a pot-shaped housing through which a rotatably drivable drill can be passed axially, and having a piston unit which is arranged axially displaceably in the housing, cooperates with a drill-side stop, contains an induced draft blower device and can be set against an associated stop on the housing side by means of a spring over which it engages, a high degree of reliability and operational safety are achieved in that at least one induced draft blower provided with its own drive motor and an energy storage unit provided with a charging socket and associated with each motor driving an associated induced draft blower are provided in the piston unit.

### CROSS REFERENCE TO RELATED APPLICATIONS

This application claims priority to German patent application DE 10 2022 003 296.1, filed Sep. 7, 2022, and the entire content of which is incorporated herein by reference.

### TECHNICAL FIELD

The invention relates to a vacuum drill dust extractor having a pot-shaped housing through which a rotatably drivable drill can be passed axially, and having a piston unit which is arranged axially displaceably in the housing, cooperates with a drill-side stop, contains an induced draft blower device and can be set against a stop on the housing side by means of a spring over which it engages.

### BACKGROUND

An arrangement of this type is known from DE 20 2020 106 108 U1. In this known arrangement, the piston unit is rotatably mounted and is driven in rotation by means of the cooperating drill or the chuck which receives it. The piston unit is also designed as an induced draft blower, which is driven accordingly by the cooperating drill or the chuck. However, the speeds used for drilling a hole are not sufficient to achieve a sufficient suction force of the induced draft blower provided here. In addition, the speed depends on the diameter of the drill bit and therefore varies from case to case. The known arrangement therefore proves to be not reliable enough.

### SUMMARY

On this basis, it is therefore an object of the present invention to improve an arrangement of the type mentioned at the beginning by simple and inexpensive means in such a way that reliable operation is ensured.

According to the invention, this object is solved by providing in the piston unit at least one induced draft blower provided with its own drive motor and an energy storage unit provided with a charging socket and associated with each induced draft blower provided.

These measures ensure that the speed and thus the power of each induced draft blower mounted on the piston unit, which is suitably secured against rotation, are completely independent of the speed of the drill and can always run at the optimum speed, so that a practically constant suction power is achieved independent of the drill and thus a high level of functional reliability. The energy storage unit, which is preferably in the form of a rechargeable battery, can simply be dimensioned so that the stored charge is sufficient for a desired number of drilling operations.

Advantageous embodiments and expedient further developments of the superior measures are indicated in the subclaims.

Thus, the piston unit, which is expediently secured against rotation, can advantageously have a rotatably mounted thrust sleeve associated with the drill-side stop. This ensures that relative movements between the drill-side stop and the piston unit acting as a counterstop are avoided, resulting in a gentle mode of operation.

In a further development of the superordinate measures, it can be provided that each induced draft blower and the energy storage unit, which is preferably in the form of a rechargeable battery, are coupled to one another by a control device to which an upwardly projecting pushbutton switch is assigned for switching each induced draft blower on and off, for which purpose the pushbutton switch interacts with the housing-side stop, which is preferably in the form of the collar of a bushing that can be screwed onto the housing. The pushbutton switch can be designed in such a way that it switches off each induced draft blower as soon as it starts together with the piston unit at the housing-side stop formed by the collar of the bushing that can be screwed onto the housing and switches on as soon as it is removed from the stop together with the piston unit. This results in an energy-saving design.

In a further development of the superordinate measures, it can be provided that the piston unit is provided with inlet and outlet openings assigned to each induced draft blower and that an air filter is provided on the inlet side, which is expediently held in contact with the air inlet-side region of the piston unit by a pot-like cover which can be detachably attached to the piston unit from below and which contains a storage space arranged upstream of the filter, which communicates with the space above the housing base via gap-shaped flow paths. The air filter ensures that the discharged air is filtered and that drill dust remains in the housing. Drill dust carried out by the air flow can be deposited in the storage space upstream of the air filter, and the flow paths can be designed to prevent drill dust from falling out even if the vacuum drill dust extractor is overturned. The accommodation of the air filter on the cover, which can be detachably attached to the piston unit, advantageously enables reliable and safe placement as well as simple and fast replacement. The aforementioned measures therefore result in a high degree of ease of operation and freedom from interference.

A further preferred further development of the superordinate measures can consist in the fact that the spring supporting the piston unit is designed as a cylindrical spring with an outer diameter adapted to the inner diameter of the housing and is enclosed by a jacket consisting of a material which is movable in itself and impermeable to air, and that the spring is clamped between the underside of the piston unit and the opposite housing base having an outlet for the drill. The said spring, together with the jacket surrounding it, provides a dust collection chamber and also ensures, as a result of its pretension, that the piston unit is reliably returned to the stop on the housing side when an axial displacement force exerted by the drill is removed, whereby the pushbutton switch of the control device can also be reliably actuated.

Expediently, the housing base may be provided with an external recess forming a channel passing between two peripheral regions. This makes handling much easier if, for example, work has to be carried out in the area of cables laid on plaster, which can run here in the channel formed by the recess.

Another further development of the superordinate measures can be that radial drill dust suction channels are provided in the area of the outlet of the housing base assigned to the drill. These ensure reliable channeling of the aspirated drill dust. The drill dust suction channels can be assigned to a bushing which can be screwed into the housing base and which has the outlet assigned to the drill from which radial tap holes form the drill dust suction channels. The use of a bushing which can be screwed into the housing base and contains the drill dust suction channels enables simple adaptation to the conditions of the individual case by providing several bushings with different drill dust suction channels which can be used as required.

A further, particularly preferable further development of the superordinate measures can be that the housing can be detachably accommodated on an associated base device which can be attached to the support to be machined with the drill and has an adjustment device directed at the center of the hole to be drilled, preferably in the form of a laser beam. These measures facilitate handling and increase accuracy. The base device can be placed against the support with the housing removed, which allows a good view of the center of the hole marked by the adjustment device. The housing can then be positioned in place, with an associated holder ensuring that the drill always hits the center point marked by the adjustment device.

To facilitate handling, it can be provided that the base device is provided with an evacuation device and can be suctioned onto the associated support.

Further advantageous embodiments and expedient further developments of the superordinate measures can be inferred from the following example description based on the drawing.

### BRIEF DESCRIPTION OF THE DRAWINGS

The invention will now be described with reference to the drawings wherein:

FIG. 1 shows a vertical section through a vacuum drill dust extractor according to the invention in the rest position with associated base device,

FIG. 2 shows a vertical section through the vacuum drill dust extractor according to the invention in operation and

FIG. 3 shows a preferred alternative with a simplified arrangement of the air filter.

### DESCRIPTION OF EXEMPLARY EMBODIMENTS

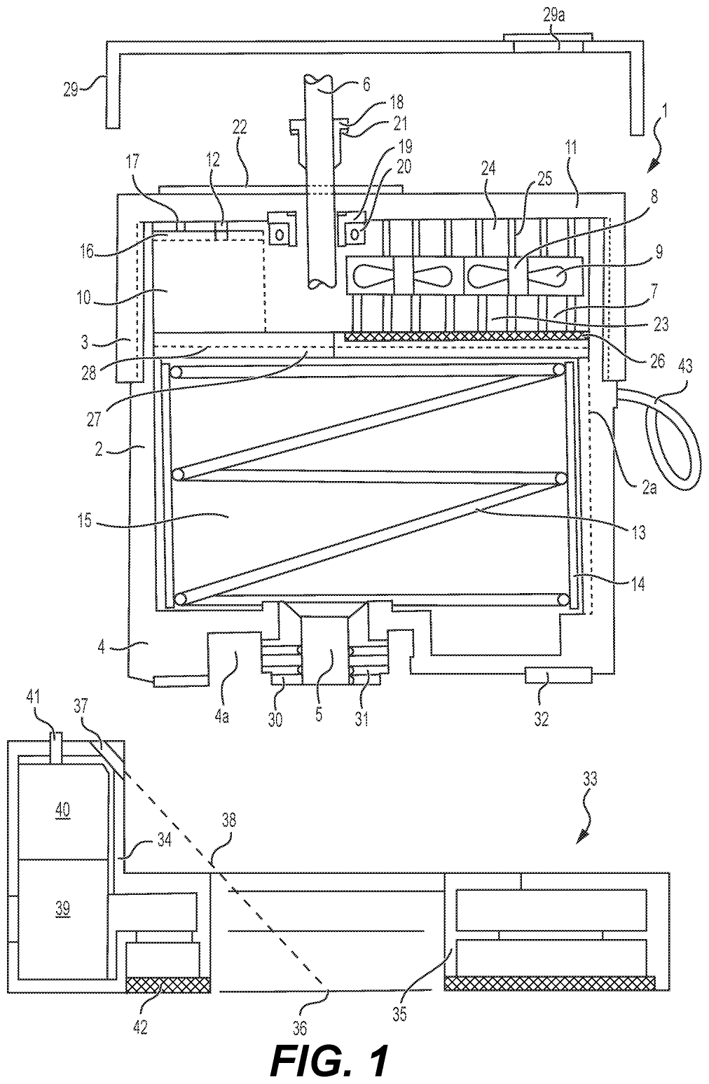

The basic structure of the arrangement on which FIGS. 1 to 3 are based is identical. The same reference numbers are therefore used for corresponding parts. The vacuum drill dust extractor 1 on which FIGS. 1 to 3 are based has a pot-shaped housing 2 which is open at the top and is provided with a sleeve 3 which can be screwed onto the upper edge and has a collar, and which is closed at the bottom by a base 4 which has an outlet opening 5 for a drill 6 which can be passed axially through the vacuum drill dust extractor 1 and is indicated in FIG. 1 only by its upper end region. The base 4 may be provided with an outer recess 4a, which is continuous between two peripheral regions and open at the bottom, and which may form a channel for passing through elevations present on the wall side, such as pipes laid on plaster, etc. A device generating a sufficient suction draft is provided for extracting the drill dust generated when drilling a hole in a building wall, etc.

For this purpose, a piston unit 7 is arranged in the housing 2 so as to be displaceable in the axial direction, which contains at least one, in this case two, induced draft blowers 9 arranged next to one another, each provided with its own drive motor 8, and an energy storage unit 10 associated with these. This can be designed as a rechargeable battery, which is provided with a charging socket 12 accessible from above radially inside the collar 11 of the sleeve 3 for charging. The piston unit 7, which is arranged in the housing 2 so as to be displaceable in an axial direction, rests with its underside on a spring 13, which is arranged below it in the housing 2 and engages under it, and is thereby placed with pretension against the collar 11 of the sleeve 3, which can be screwed onto the housing 2 and practically forms an adjustable upper stop for the piston unit 7.

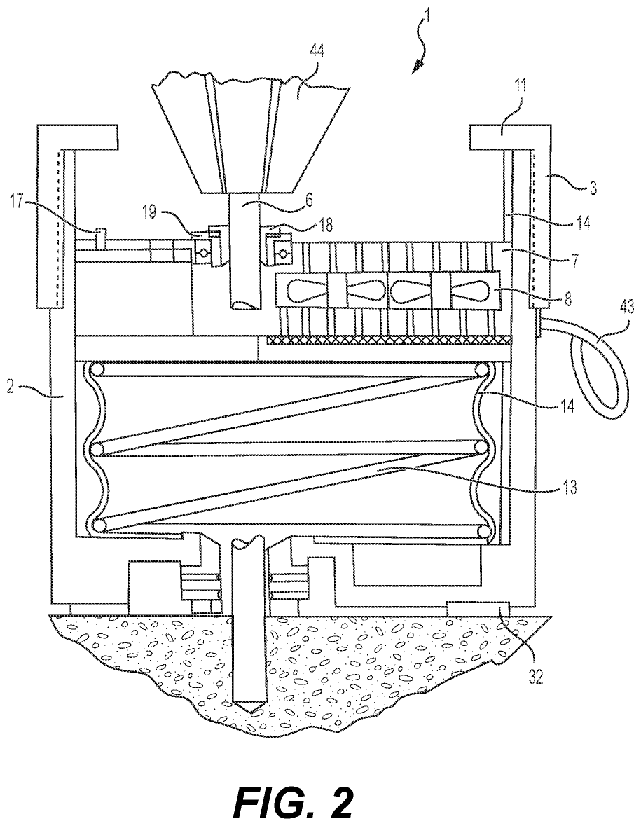

The spring 13 is designed as a large-pitch cylindrical spring with an outer diameter adapted to the inner diameter of the housing 2, the lower end of which is supported on the inside of the base 4 of the housing 2 and the upper end of which is supported on the underside of the piston unit 7, so that the latter is reliably pushed back from an operating position on which FIG. 2 is based, lifted from the stop formed by the collar 11, into the stop position on which FIG. 1 is based, when a downward force ceases. The spring 13 has the appropriate pretension for this purpose. The spring 13 may be enclosed by a jacket 14 which is made of an air-impermeable material which is movable in itself. In this way, a chamber 15 is formed which is bounded in a radial direction by the jacket 14 and in an axial direction by the base 4 of the housing 2 and the piston unit 7 and which, in an embodiment according to FIGS. 1 and 2, can function as a dust container. In operation, i.e., when the piston unit 7 is moved away from the collar 11 acting as a stop by the drill 6 in the feed direction of the drill 6, the spring 13 is compressed and the jacket 14 is folded in an accordion-like manner, as schematically indicated in FIG. 2. As a result, the closed chamber 15 is retained. It is merely reduced in size somewhat.

For the electrical coupling of the energy storage unit 10 with the associated drive motor 8 of each induced draft blower 9, a control device can be provided which is accommodated on a circuit board 16 and has a pushbutton switch 17 which is arranged in the radial region of the collar 11 of the sleeve 3 acting as a stop and can be extended upwards. This can be designed to switch off the induced draft blower 8 when it is pressed against the collar 11 by starting up and vice versa. FIG. 1 is based on the stop position in which the induced draft blowers 8 are switched off and therefore do not consume any energy. FIG. 2 shows the operating position in which the pushbutton switch 17 is free and the induced draft blowers 8 are therefore running.

During drilling, the piston unit 7, which is secured against rotation in the housing 2 by an axial guide 2a, is pressed down against the force of the spring 13 by the drill 6 passing through it and thus moved away from the collar 11 acting as a stop as shown in FIG. 2. In the example shown, the drill 6 is provided for this purpose with a stop 18 formed by a drawn-on or glued-on flange ring or the like, which cooperates with the piston unit 7 during an advance movement of the drill 6. For this purpose, this can be provided with a thrust sleeve 19 associated with the stop 18, which can be freely rotatably mounted in the piston unit 7, as indicated by ball bearings 20. To avoid a grinding relative movement, the flange ring forming the stop 18 and the thrust sleeve 19 can be provided with mutually associated toothings 21 which come into mutual engagement in the driving position on which FIG. 1 is based.

When the drill bit 6 is removed. i.e. when the vacuum drill dust extractor 1 is at a standstill, the lead-through recess of the start-up bush 19 can be covered by a rotary slide 22 rotatably arranged on the collar 11 of the sleeve 3 in order to prevent dust and debris from outside from entering the interior of the vacuum drill dust extractor 1.

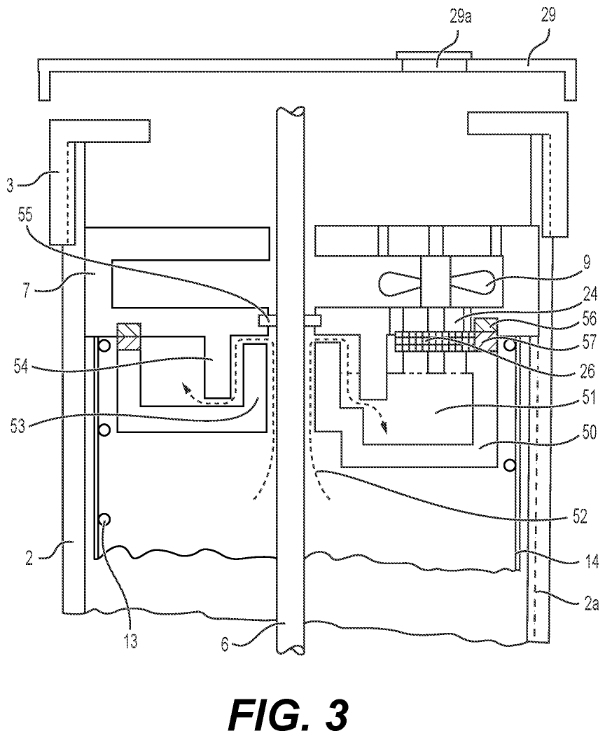

The piston unit 7 has inlet and outlet openings 23, 24 associated with their induced draft blowers 8, each of which may be associated with a rust-type engagement guard 25. An air filter 26 is associated with the lower inlet opening. According to FIGS. 1 and 2, this can be accommodated on a drawer 27, which can be slidably mounted on the underside of the piston unit 7 by means of a sliding guide 28 extending transversely to the longitudinal axis of the housing 2. A preferred alternative that does not require a drawer is shown in FIG. 3, which is described further below.

In the example according to FIGS. 1 and 2, the dust produced when drilling a hole in a building wall etc. and sucked in by the induced draft blower 9 settles in the space radially bounded by the jacket of the spring 13 and must be removed therefrom from time to time. For this purpose, the space can be opened and emptied. Expediently, however, the space 15 can be sucked out by means of a vacuum cleaner. In order to make this possible, a sealing cap 29 can be provided which can be fitted onto the sleeve 3 after removal of the drill bit 6 and which can have a closable opening 29a for attaching a vacuum cleaner tube etc. During this suction process, the rotary slide 22 is naturally in its open position.

During drilling, the drill dust is sucked in via the outlet opening 5 provided in the region of the base 4 of the housing 2 and associated with the drill 6. As in the example shown, this can be associated with a bushing 30 screwed into an associated opening in the base 4, which is expediently provided with stub holes 31 arranged in a star shape extending radially from its hole forming the outlet 5 to form drill dust suction channels.

In simple cases, the vacuum drill dust extractor according to the invention can be placed directly on the wall to be machined by means of the drill 6, as FIG. 2 shows. For this purpose, the housing 2 is provided with contact pads 32 on the bottom side to enable gentle contact. In cases of this type, however, it requires greater skill to position a drill hole precisely.

To facilitate handling, therefore, as FIG. 1 shows, a base device 33 can be provided which can be attached to the wall to be machined and which is provided with a socket 34 for the housing 2 of the vacuum drill dust extractor 1 which can be brought into detachable engagement therewith. The base device 33 is provided with a comparatively large passage opening 35 associated with the outlet 5 of the vacuum drill dust extractor 1, within which the center point 36 of the bore to be produced lies. In this connection, the socket 34 associated with the housing 2 is designed in such a way that the drill bit 6 passing through the vacuum drill dust extractor 1, which is brought into engagement with the socket 34 by means of its housing 2, strikes the center point 36. To indicate the center point 36, the base device 33 can expediently be provided with an adjusting device. As indicated in FIG. 1, this can be designed as a laser device which has a laser gun 37 which emits a laser beam 38 which impinges precisely on the center point 36.

The base device 33 is conveniently fixed immovably to the associated support. For this purpose, the base device 33 can be provided with a suitable evacuation device for suction. Advantageously, the base device 33 contains an evacuation blower 39 assigned to an inner chamber with its own drive motor, to which an energy storage unit 40, expediently again in the form of a rechargeable battery, and an inching switch 41 for switching on and off are assigned. The vacuum generated when the evacuation blower 39 is activated acts within the cavity of the base device 33, which is expediently designed as a hollow body and forms said inner chamber, and which is provided on the system side, i.e., in FIG. 1 at the bottom, with suction openings sealed by a ring seal 42 in each case.

The fixing of the housing 2 of the vacuum drill dust extractor 1 in the socket 34 of the base device 33 can be designed as a plug-in closure. Expediently, a magnetic closure can be provided to facilitate handling. For this purpose, magnetic rings can be provided on both sides, which attract each other when approached.

In order to avoid having to put the vacuum drill dust extractor 1 out of the hand when attaching the base device 33 to the associated support, the housing 2 can be provided with a cord 43 forming a holding loop, which makes it possible to hang the vacuum drill dust extractor 1 on a wrist, so that the hand in question is free to work, but the vacuum drill dust extractor 1 is always at hand, which greatly facilitates handling. In simple cases, as has already been indicated above, it is possible to dispense with the use of the base device 33 and to place the housing 2 of the vacuum drill dust extractor 1 directly on the base to be worked on by means of the drill 6, as FIG. 2 shows.

In the illustration according to FIG. 2, as already mentioned above, the drill-side stop 18 of the drill 6 clamped here in a drill chuck 44 of a hand drill, etc., is in engagement with the thrust sleeve 19 of the piston unit 7, which here is moved away from the upper stop formed by the collar 11 of the sleeve 3 in the axial working direction of the drill 6 by the drill 6 moving in the axial direction. This also releases the pushbutton switch 17 so that the induced draft blowers 8 are switched on. The axial movement of the piston unit 7 caused by the drill 6, which is secured against rotation by the axial guide 2a, takes place against the force of the spring 13, which is thereby compressed, as has also been mentioned above. The jacket 14, which consists of a material that is movable in itself, permits this compression and forms accordion-like folds in the process, as indicated in FIG. 2. After the feed force exerted by the drill 6 has ceased, the piston unit 7 is moved back by the spring 13, as has also already been mentioned in connection with FIG. 1, and is set against the stop formed by the collar 11, as a result of which the pushbutton switch 17 is also pressed and thus the induced draft blowers 8 are switched off, so that no energy is consumed as long as the vacuum drill dust extractor 1 is not in use.

The correct insertion of the air filter 26 into the drawer 27 of the embodiment according to FIGS. 1 and 2 may prove to be difficult under certain circumstances. To remedy this, in the embodiment according to FIG. 3 a pot-shaped cover 50 is provided for holding the air filter 26, which can be detachably attached to the underside of the piston unit 7 and presses the air filter 26 against the underside of the air inlet-side region of the piston unit 7, which is expediently covered by a grate. The pot-shaped cover 50 contains a storage space 51 upstream of the air filter 26 in terms of flow, which communicates with the space provided on the housing side above the base 4 of the piston unit 7, not shown in FIG. 3, via flow paths 52 indicated by dashed lines in FIG. 3, so that the drill dust brought in by the air flow generated by the induced draft blowers 9 reaches the storage space 51 and can be deposited there. The flow paths 52 are formed by structurally provided gaps between the drill 6 passing through the piston unit 7 and the cover 50 attached thereto and an inner collar 53 of the cover 50 forming a passage opening for the drill, as well as between the end face of the inner collar 53 and the underside of the piston unit 7 and between the inner collar 53 and an opening adjacent thereto, and an outer collar 54 projecting downward from the underside of the piston unit 7. The inner collar 53 and the outer collar 54 encompassing the latter practically form a labyrinth which prevents the drill dust from falling out if the housing 2 is overturned. To prevent false air that can be drawn in from above, a suitable seal 55 can be provided in the lower region of the feed-through opening of the piston unit 7 associated with the drill 6. This can suitably be designed as an elastically yielding lip seal, etc., which can adapt to different drill diameters.

A threaded connection can be provided for detachable fastening of the cover 50 to the piston unit 7. In the exemplary embodiment shown in FIG. 3, a magnetic holder is provided for this purpose, which is expediently formed by mutually attracting magnetic rings 56, 57 provided on the piston unit side and on the cover side. The spring 13 elastically supporting the piston unit 7 is also required in the embodiment according to FIG. 3. The jacket 14 surrounding the spring 13 may be provided here, but is not absolutely necessary, since the drill dust is collected in the storage space 51. To empty the storage space 51, it can be opened and emptied. However, as in the embodiments according to FIGS. 1 and 2, it is also expedient here to provide suction by means of a vacuum cleaner which can be attached to a sealing cap 29 provided with an opening 29a and which can be placed on the sleeve 3 after removal of the drill bit 6.

It is understood that the foregoing description is that of the exemplary embodiments of the invention and that various changes and modifications may be made thereto without departing from the spirit and scope of the invention as defined in the appended claims.

What is claimed is:

1. A vacuum drill dust extractor having a pot-shaped housing through which a rotatably drivable drill can be passed axially, and having a piston unit which is arranged axially displaceably in the housing, cooperates with a drill-side stop, contains an induced draft blower device and can be set against an associated stop on the housing side by means of a spring over which it engages, whereby at least one induced draft blower provided with its own drive motor and an energy storage unit provided with a charging socket and associated with each drive motor driving an associated induced draft blower are provided in the piston unit.

2. The vacuum drill dust extractor according to claim 1, whereby the piston unit has a rotatably mounted thrust sleeve associated with the drill-side stop.

3. The vacuum drill dust extractor according to claim 1, whereby the axially displaceably arranged piston unit is secured against rotation by an axial guide device.

4. The vacuum drill dust extractor according to claim 1, whereby each drive motor associated with an induced draft blower and the energy storage unit, which is preferably in the form of a rechargeable battery, are coupled to one another by a control device which is assigned a pushbutton switch, which is accessible from above, for switching each drive motor on and off, which pushbutton switch interacts with the housing-side stop, which is preferably in the form of a collar of a collar sleeve which can be screwed onto the housing.

5. The vacuum drill dust extractor according to claim 1, whereby the piston unit is provided with inlet and outlet openings associated with each induced draft blower, and in that an air filter is provided on the inlet side, which is held in contact with the air inlet-side region of the piston unit by a pot-like cover which can be detachably attached to the piston unit from below, wherein the cover contains a storage space which is arranged upstream of the air filter and communicates with the space above the base of the housing via gap-like flow paths.

6. The vacuum drill dust extractor according to claim 1, whereby the spring supporting the piston unit is designed as a cylindrical spring with an outer diameter adapted to the inner diameter of the housing and is surrounded by a jacket consisting of a material which is movable in itself and impermeable to air, and in that the spring is arranged with pretension between the underside of the piston unit and the inner side, opposite thereto, of the base of the housing, which has an outlet for the drill.

7. The vacuum drill dust extractor according to claim 1, whereby the housing is provided on the bottom side with an outer recess forming a channel passing continuously between two peripheral regions.

8. The vacuum drill dust extractor according to claim 1, whereby radial drill dust suction channels are provided in the region of the outlet of the housing base assigned to the drill, wherein a bushing is provided which can be screwed into the housing base and is provided with a central bore forming the outlet assigned to the drill and radial stub bores extending therefrom for forming the drill dust suction channels.

9. The vacuum drill dust extractor according to claim 1, whereby the housing is detachably receivable on an associated base device which is attachable to the support to be machined with the drill and has an adjustment device in the form of a laser beam directed towards the center point of the hole to be drilled.

10. The vacuum drill dust extractor according to claim 9, whereby the base device is provided with a vacuum device and can be fixed by means thereof to the associated base.
